(19) United States
(12) Patent Application Publication
(10) Pub. No.: US 2011/0318625 A1
(43) Pub. Date: Dec. 29, 2011

(54) BATTERY MODULE

(76) Inventors: Seijiro Yajima, Yongin-si (KR); Tae-Yong Kim, Yongin-si (KR); Kwon Sohn, Yongin-si (KR)

(21) Appl. No.: 12/902,044

(22) Filed: Oct. 11, 2010

(30) Foreign Application Priority Data
Jun. 24, 2010 (KR) 10-2010-0060117

(51) Int. Cl. H01M 10/50

(52) U.S. Cl. 429/120

(57) ABSTRACT

A battery module according to an exemplary embodiment of the present invention includes: a plurality of rechargeable batteries; a housing incorporating the rechargeable batteries; and a plurality of protrusions allowing the rechargeable batteries to be spaced from each other in order to acquire a stable cooling function, wherein the rechargeable batteries are stacked and arranged to form a plurality of battery arrays and the battery arrays stacked in a flow direction of the cooing medium are different from each other in the number of protrusions located between the rechargeable batteries.

### CROSS-REFERENCE TO RELATED APPLICATION

This application claims priority to and the benefit of Korean Patent Application No. 10-2010-0060117 filed in the Korean Intellectual Property Office on Jun. 24, 2010, the entire contents of which are incorporated herein by reference.

### BACKGROUND OF THE INVENTION

1. Field of the Invention

The present invention relates to a battery module.

2. Description of the Related Art

Rechargeable batteries can be repeatedly charged and discharged unlike primary batteries which cannot be repeatedly charged. Low-capacity rechargeable batteries are used for portable compact electronic apparatuses such as mobile phones, notebook computers and camcorders and high-capacity rechargeable batteries are widely used as a power source for driving a motor of a hybrid vehicle, etc.

Recently, a high-output rechargeable battery using a non-aqueous electrolyte having high energy density has been developed. The high-output rechargeable battery is configured with a high-output rechargeable battery module by connecting a plurality of rechargeable batteries in series so as to be used for driving an apparatus requiring a large power, e.g., motor of an electrical vehicle, etc.

The battery module includes several rechargeable batteries. Therefore, heat generated from each of the rechargeable batteries should be easily emitted. When heat is not normally emitted, the internal temperature of the rechargeable battery increases and as a result, adverse reactions occur, thereby shortening the life-span of the rechargeable battery. Further, when the temperature of the rechargeable battery is continuously increased, the rechargeable battery may catch fire or explode.

Conventionally, a scheme of blowing and supplying outdoor air is adopted in order to cool the battery module, but when the outdoor air is blown and supplied, foreign materials such as dust and the like may be introduced into the battery module, thereby potentially damaging the battery module due to a short-circuit, and the like.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a battery module having a stable cooling function.

An exemplary embodiment of the present invention provides a battery module that comprises: a plurality of batteries stacked together to form a plurality of battery arrays, wherein a first group of the battery arrays are aligned together and a second group of the battery arrays are aligned together, and wherein the first group and the second group are spaced from each other to create a cooling medium flow path therebetween, the cooling medium flow path having a first end and a second end; a housing accommodating the batteries; and a plurality of protrusions on each of the batteries and spacing the batteries from each other, wherein a number of protrusions on a first battery of the batteries is different from a number of protrusions on a second battery adjacent to the first battery with respect to a flow direction of the cooling medium flow path.

The first battery may be located closer to the first end of the cooling medium flow path than the second battery and the number of protrusions on the first battery may be greater than the number of protrusions on the second battery.

The protrusions may be spaced from each other on an outer surface of each of the batteries. A width of a first protrusion of the protrusions located on the first battery may be greater than a width of a second protrusion of the protrusions located on the second battery.

A length of a first protrusion of the protrusions located on the first battery may be less than a length of a second protrusion of the protrusions located on the second battery. The protrusions may comprise guide protrusions that are elongate and extend generally in a direction from the first end to the second end of the cooling medium flow path.

The housing may be sealed and is configured to allow the batteries to be cooled by convection. In an operating orientation, the first battery may be located beneath the second battery.

A cooling medium in the cooling medium flow path may be heated by the batteries to move upwards from the first end to the second end of the cooling medium flow path. The first group of battery arrays may extend along a first side of the cooling medium flow path and the second group of battery arrays may extend along a second side of the cooling medium flow path substantially parallel to the first group.

The battery module may further comprise a partitioning member. The first group and the second group of battery arrays may be within the partitioning member. A cooling space may be defined within the partitioning member and a moving space may be defined outside of the partitioning member. A cooling medium can move between the cooling space and the moving space. The partitioning member may comprise a thermal insulating material.

The battery module may further comprise a guide member formed on the partitioning member. The guide member may extend obliquely from the partitioning member into the moving space. The battery module may further comprise a bottom plate configured to be exposed to exterior air.

The battery module may further comprise a cooling member connected to the housing. The cooling member may be located at generally one end of the housing.

The cooling member may be located at an edge of the housing. The cooling member may have an opening and a heat insulating member may be in the opening and contact the housing.

The protrusions may be fixed to a case of the battery. The protrusions may be fixed to a plate located between the batteries.

The protrusions may comprise guide protrusions that are elongate and extend in a flow direction of the cooling medium flow path and dot protrusions having a greater width and a shorter length than the guide protrusions.

The dot protrusions may be closer to a first end of the flow path channel than the guide protrusions.

Another exemplary embodiment of the present invention provides a battery module that comprises: a plurality of batteries stacked together to form a plurality of battery arrays, wherein a first group of the battery arrays are aligned together and a second group of the battery arrays are aligned together and the first group and the second group are spaced from each other to create a cooling medium flow path therebetween, the cooling medium flow path having a first end and a second end; and a housing accommodating the batteries, wherein a first battery of the batteries located closer to the first end than a second battery of the batteries provides more flow resistance to cooling medium flow in the cooling medium flow path than the second battery.

According to the exemplary embodiments of the present invention, the cooling medium is further well circulated in the housing to thereby improve cooling efficiency, since the speed of the cooling medium is further increased while the cooling medium cools heat of a plurality of batteries. Further, buoyancy increases and the speed of the cooling medium is further increased, since the cooling medium is further heated as the speed of the cooling medium increases.

In particular, the housing can be formed in a sealing type and the rechargeable batteries can be cooled by a convection method, since the cooling medium is normally circulated.

### BRIEF DESCRIPTION OF THE DRAWINGS

FIG. 1 is a cross-sectional view of a battery module according to a first exemplary embodiment of the present invention;

FIG. 2 is a perspective view of battery arrays according to a first exemplary embodiment of the present invention;

FIG. 3 is a perspective view of rechargeable batteries according to a first exemplary embodiment of the present invention;

FIG. 4 is a cross-sectional view of a battery module according to a second exemplary embodiment of the present invention;

FIG. 5 is a cross-sectional view of a battery module according to a third exemplary embodiment of the present invention;

FIG. 6 is a cross-sectional view of a battery module according to a fourth exemplary embodiment of the present invention;

FIG. 7 is an exploded perspective view of rechargeable batteries constituting a battery module according to a fifth exemplary embodiment of the present invention; and

FIG. 8 is a cross-sectional view of a battery module according to a sixth exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. In addition, like reference numerals denote like elements in the specification and the accompanying drawings.

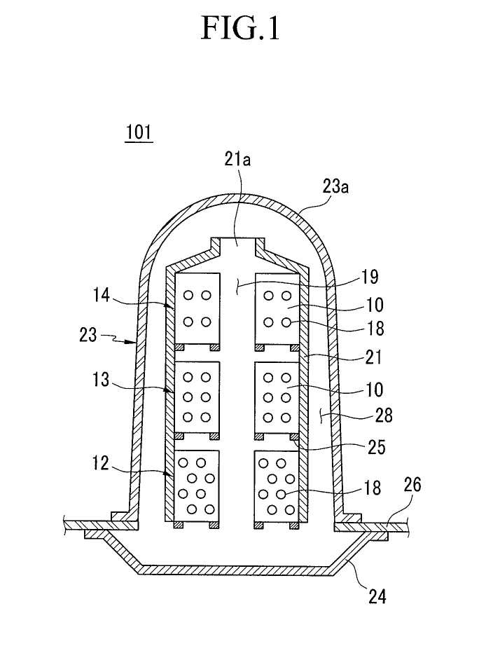

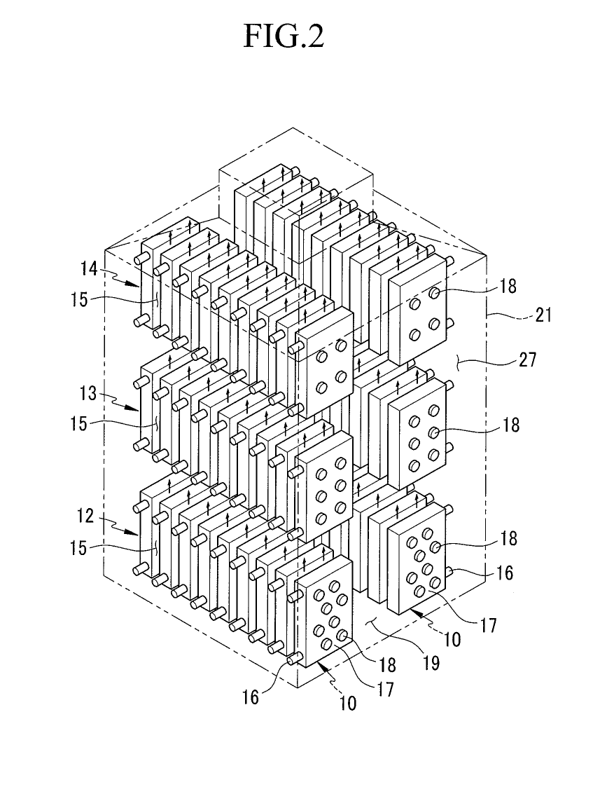

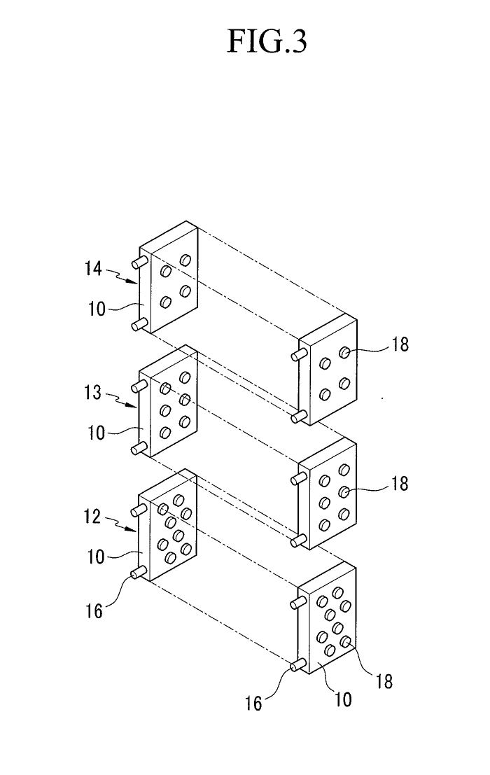

FIG. 1 is a cross-sectional view of a battery module according to a first exemplary embodiment of the present invention, FIG. 2 is a perspective view of battery arrays according to a first exemplary embodiment of the present invention, and FIG. 3 is an exploded perspective view of rechargeable batteries and protrusions according to a first exemplary embodiment of the present invention.

Referring to FIGS. 1 to 3, the battery module 101 according to the first exemplary embodiment of the present invention includes a plurality of rechargeable batteries (e.g., batteries) 10, a housing 23 having space accommodating the rechargeable batteries 10 therein, and a protrusion 18 located between the rechargeable batteries 10 and forming space wherein a cooling medium moves.

The rechargeable batteries 10 may be lithium ion rechargeable batteries and may have a prismatic shape such as a substantially rectangular parallelepiped shape. However, embodiments of the present invention is not limited thereto, but rather may be applied to various types of batteries such as a lithium polymer battery or a cylindrical battery.

The rechargeable batteries 10 are stacked and arranged in parallel to form battery arrays 12, 13, and 14 and a plurality of battery arrays are accommodated in the housing 23. The battery arrays 12, 13, and 14 are stacked and arranged in parallel to a flow direction of the cooling medium and are arranged in two lines or two groups to form a center passage 19 therebetween and extending along the flow direction of the cooling medium.

The battery arrays 12, 13, and 14 are spaced from each other in a direction crossing the flow direction of the cooling medium with the center passage 19 located therebetween, thus the cooling medium can move through the center passage 19 and the battery arrays 12, 13, and 14.

In the exemplary embodiment, three battery arrays 12, 13, and 14 are stacked and arranged in the flow direction of the cooling medium, but the present invention is not limited thereto and could include two or more battery arrays stacked and arranged.

The protrusion 18 is located between the rechargeable batteries 10 to allow the rechargeable batteries 10 to be spaced from each other. As a result, a passage 15 through which the cooling medium moves is formed between the rechargeable batteries 10.

The protrusion 18 according to the exemplary embodiment may be a dot protrusion which has a circular cross section, but the present invention is not limited thereto and the dot protrusion may be formed in various cross-sectional shapes such as a triangular shape, a quadrangular shape, and the like. The dot protrusion 18 is fixed to a case 17 forming an external surface of the rechargeable battery 10. The dot protrusion 18 may be formed integrally with the case 17 of the rechargeable battery 10 to protrude from the case 17, and may be fixed to the case 17 by an adhesive, or the like.

The housing 23 has a hexahedral shape and has a structure in which a cross sectional area increases in one direction (downward as shown in FIG. 1). Further, the top 23a of the housing 23 is formed to have an arc-shaped cross section. As a result, the cooling medium which ascends is guided by the top 23a of the housing 23 to easily move to an edge.

Meanwhile, a partitioning member 21 is installed in the housing 23 to provide a partitioning space through which the cooling medium moves. The partitioning member 21 is made of a thermal insulating material and has a substantially hexahedral shape. Further, the partitioning member 21 defines a cooling space 27 adjacent to the battery arrays 12, 13, and 14 to allow a cooling medium to pass through the battery arrays 12, 13, and 14 and a moving space 28 outside of the cooling space 27 allowing the cooling medium to be circulated and reintroduced into the cooling space 27.

A first end and a second end of the partitioning member 21 are open to allow the cooling medium to be introduced into the partitioning member 21 and discharged therefrom. Further, the partitioning member 21 is spaced from the housing 23 and the moving space 28 is formed between the partitioning member 21 and the housing 23. The moving space 28 has a structure in which a cross section gradually increases along the flow direction of the cooling medium. As a result, when a cooling medium such as air discharged from the cooling space 27 moves through the moving space 28, the velocity of the air slows. Also, the cooling medium is in contact with the housing 23 for an increased amount of time to thereby cool the cooling medium more quickly.

Further, a bottom plate 24 which is in contact with external air is installed below the housing 23. When the battery module 101 is installed in, for example, an electric car or a hybrid car, the battery module 101 may be located in a rear trunk and the bottom plate 24 protrudes from the bottom of the vehicle to the outside to be installed in contact with the outdoor air. As a result, the bottom plate 24 is cooled by the outdoor air and the cooling medium discharged from the cooling space 27 may be cooled through the housing 23 and the bottom plate 24. The housing 23 and the bottom plate 24 may be made of aluminum, steel, stainless steel, or the like having high thermal conductivity. The internal space of the housing 23 is sealed by the housing 23 and the bottom plate 24, and air, which is the cooling medium, is introduced into the internal space.

A frame 25 supporting the battery arrays 12, 13, and 14 is installed on the partitioning member 21. The frame 25 has a bar shape and serves to support the battery arrays 12, 13, and 14 that are fixed to the partitioning member 21 to stably position the battery arrays 12, 13, and 14.

The friction of the cooling medium with the passage 15 of the battery arrays 13 and 14 located in the latter part of the flow direction of the cooling medium (e.g., a first end of the cooling medium flow path) is less than the friction of the cooling medium with the passage 15 of the battery array 12 located in the earlier part of the flow direction of the cooling medium (e.g., a second end of the cooling medium flow path). In other words, the battery arrays 13,14 provide less resistance to flow of the cooling medium in the cooling medium flow path than the battery array 12.

To achieve this, in one embodiment the number of protrusions 18 arranged between the rechargeable batteries 10 of the battery arrays 13 and 14 located on the latter part of the flow direction of the cooling medium is less than the number of protrusions 18 located between the rechargeable batteries 10 of the battery array 12 located in the earlier part of the flow direction of the cooling medium.

The protrusions 18 are spaced from each other. In one embodiment, eight protrusions 18 are installed in the rechargeable battery 10 of the battery array 12 located in the earliest part (initial part) of the flow direction of the cooling medium, six protrusions 18 are installed in the rechargeable battery 10 of the battery array 13 located in the center, and four protrusions are in the rechargeable battery 10 of the battery array 14 located in the latter part of the flow direction of the cooling medium. Herein, the protrusions 18 installed in the rechargeable battery 10 of the battery array 14 located in the earliest part are arranged to cross each other (i.e., they are not aligned with an adjacent protrusion with respect to the flow direction of the cooling medium) to thereby further increase the friction between the cooling medium and the dot protrusion 18.

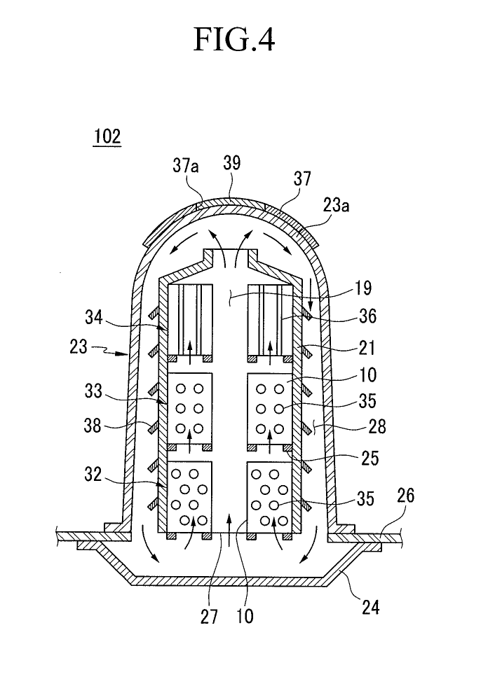

In one embodiment, the cooling medium is formed by air and moves substantially in parallel to a direction in which the battery arrays 12, 13, 14 are spaced form each other, as shown for example in FIGS. 1 and 4. Therefore, the battery arrays 13 and 14 located in the latter part of the flow direction of the cooling medium are located higher than the battery array 12 located in the earlier part of the flow direction of the cooling medium when the battery module is oriented upright in an operating orientation, as shown in FIG. 1.

Air heated by the rechargeable batteries 10 is moved upwards by buoyancy in the cooling space 27 and as the air moves upwards, the air is heated to thereby increase the moving velocity.

The moving velocity of the cooling medium increases as the cooling medium moves upwards, such that the cooling medium moves to the outside of the partitioning member 21. The cooling medium discharged from the cooling space 27 formed in the partitioning member 21 is cooled by exchanging heat with the housing and air cooled in the upper part moves downwards through the moving space 28. Further, convection in which the air moves from the moving space 28 to the cooling space 27 having lower pressure occurs. The rechargeable batteries 10 are cooled through convection by the cooling medium.

In one embodiment, since comparatively many protrusions 18 are formed in the lower part, the cooling medium slowly moves upwards. However, the number of protrusions 18 decreases towards the top so that the moving velocity of the cooling medium is increased. The temperature of the cooling medium increases due to the rechargeable batteries 10 and causes the cooling medium to move upwards. The moving velocity of the cooling medium increases as it moves upwards due to the arrangement of the protrusions 18. As a result, the cooling medium which moves upward pushes out the cooling medium which is located higher than the above-mentioned cooling medium to circulate the cooling medium through the housing 23.

The moving velocity of the cooling medium helps convection. Therefore, as the moving velocity of the cooling medium increases, cooling by convection may increase. According to the exemplary embodiment, since the flow resistance of the passage of the cooling medium of the battery arrays 13 and 14 located in the latter part of the moving direction of the cooling medium is less, the moving velocity of the cooling medium increases as the cooling medium moves upwards. As a result, cooling efficiency is improved.

Further, the cooling medium flowing upwards and the cooling medium flowing downwards are separated from each other by the partitioning member 21. Therefore, since convection may more easily occur and the cooling medium is cooled by the housing 23 and the bottom plate 24, the cooling medium which flows upwards transfers heat to the housing 23 and thereafter, flows downwards and circulates.

As such, according to the exemplary embodiment, since the rechargeable batteries 10 are cooled by the convection and the cooling medium is recycled, it is possible to prevent external foreign materials from being introduced.

FIG. 4 is a cross-sectional view of a battery module according to a second exemplary embodiment of the present invention.

Referring to FIG. 4, the battery module 102 according to the exemplary embodiment has substantially the same structure as the battery module according to the first exemplary embodiment except for the structure of the protrusions 35 and 36 and the addition of cooling member 37 and the guide members 38. Therefore, the same structure will not be described again.

The battery module 102 according to the exemplary embodiment includes a plurality of battery arrays 32, 33, and 34 and a housing 23, and protrusions 35 and 36 located between the rechargeable batteries 10 of the battery arrays 32, 33, and 34.

The protrusions include a dot protrusion 35 and a guide protrusion 36. Herein, the dot protrusions 35 have a circular or polygonal cross and are spaced from each other in the flow direction of the cooling medium on the surface of one rechargeable battery. The guide protrusions 36 are substantially rectangular protrusions extending in the flow direction of the cooling medium.

The number of guide protrusions 36 located between the rechargeable batteries 10 of the battery array 34 located in the latter part of the flow direction of the cooling medium is smaller than the number of dot protrusions 35 located between the rechargeable batteries 10 of the battery array 32 and 33 located in the earlier part of the flow direction of the cooling medium.

A plurality of dot protrusions 35 are spaced from each other in the flow direction of the cooling medium in one rechargeable battery 10. Eight protrusions 35 are installed in the rechargeable battery 10 of the battery array 32 located in the earliest part of the flow direction of the cooling medium and six protrusions 35 are installed in the rechargeable battery 10 of the battery array 33 disposed at the center.

In one embodiment, the length of the guide protrusion 36 located between the rechargeable batteries 10 of the battery array 34 in the latter part of the flow direction of the cooling medium is greater than the length of the dot protrusions 35 located between the rechargeable batteries of the battery array 34 located in the earlier part of the flow direction of the cooling medium. Further, the width of the guide protrusion 36 in the latter part of the flow direction of the cooling medium is smaller than the width of the dot protrusions 35 located in the earlier part of the flow direction of the cooling medium.

That is, the plurality of guide protrusions 36 extending in the flow direction of the cooling medium are spaced from each other to allow a cooling medium to flow therebetween in the flow direction.

The guide protrusion 36 has a bar shape extending in the flow direction of the cooling medium and extends from one end to the other end of the rechargeable battery 10.

The guide protrusion 36 reduces a cross section of the cooling medium passage or flow path without interrupting the flow of the cooling medium. As a result, the velocity of the cooling medium is further increased. In other words, the protrusions 35 having a large width and a short length interrupts the progression of the cooling medium and distributes the cooling medium, but the guide protrusion 36 serves to reduce only the cross section of the cooling medium passage and allows the cooling medium to progress more rapidly.

As such, according to the exemplary embodiment, since the velocity of the cooling medium further increases toward the latter part with respect to the flow direction of the cooling medium, the convection in the housing may more actively occur.

The guide member 38 protrudes obliquely in the flow direction of the cooling medium and is installed on an outer surface of the partitioning member 21. The guide member 38 has a plate shape formed obliquely in the flow direction of the cooling medium and serves to prevent the cooling medium from flowing backward in the moving space 28.

Further, the cooling member 37 is installed on the top 23a of the housing 23. The cooling member 37 serves to cool the housing 23 by receiving heat from the housing 23. The cooling member 37 may have various structures and may be made of a thermoelectric element, a metal plate transferring heat to other members, or the like.

A hole (e.g., opening) 37a is formed at the center the cooling member 37 and a heat insulating member 39 is inserted into the hole 37a to be in contact with the housing 23. As a result, the center portion of the housing 23 is not cooled as much and only the edge portion of the housing 23 is cooled. As a result, the heated cooling medium may move upwards at high speed towards the center portion of the housing 23 and the cooling medium which moves upwards is cooled while moving to the edge of the housing 23. The cooling medium which is cooled at the edge of the housing 23 moves downwards in the moving space 28 to cause the convection to more actively occur. As a result, cooling efficiency is improved.

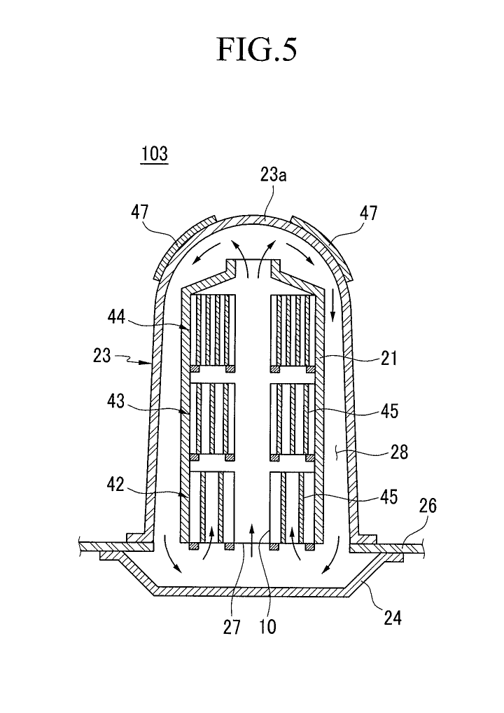

FIG. 5 is a cross-sectional view of a battery module according to a third exemplary embodiment of the present invention.

Referring to FIG. 5, the battery module 103 according to the exemplary embodiment has substantially the same structure as the battery module according to the first exemplary embodiment except for the structure of a guide protrusion 45 and the addition of a cooling member 47. Therefore, the same structure will not be described again.

The battery module 103 according to the exemplary embodiment includes a plurality of battery arrays 42, 43, and 44 and a housing 23, and guide protrusions 45 located between rechargeable batteries 10 of the battery arrays 42, 43, and 44.

The plurality of guide protrusions 45 that extend in a flow direction of a cooling medium are spaced from each other between the rechargeable batteries 10 to allow a cooling medium to flow along a length of the protrusions. Each guide protrusion 45 has a bar shape that extends in the flow direction of the cooling medium and extends from one end to the other end of the rechargeable battery 10.

The number of guide protrusions 45 of the rechargeable batteries of the battery array 44 located in the most latter part of the flow direction of the cooling medium is larger than the number of guide protrusions 45 located between the rechargeable batteries 10 of the battery array 42 and 43 located in the earlier part of the flow direction of the cooling medium.

The guide protrusion 45 reduces a cross section of a cooling medium passage without significantly interrupting the flow of the cooling medium. Therefore, when the number of guide protrusions 45 is increased, the width of the cooling medium passage is decreased. As a result, since the cross section of the passage is decreased, the moving velocity of the cooling medium is further increased and as the cross section of the cooling medium passage decreases, the friction between the cooling medium and the cooling medium passage is decreased.

As such, according to the exemplary embodiment, since the velocity of the cooling medium further increases toward the latter part with respect to the flow direction of the cooling medium, the convection in the housing 23 may more actively occur.

Further, the cooling member 47 is installed at the edge of the top 23a of the housing 23. The cooling member 47 serves to cool the housing 23 by receiving heat from the housing 23. The cooling member 47 may be formed in various configurations and may be made of a thermoelectric element, a metal plate transferring heat to other members, or the like. As described in the exemplary embodiment, when the cooling member 47 is installed at the edge of the top 23a of the housing 23, the cooling medium which is heated by the rechargeable battery 10 and thus moves upwards may easily move downwards on a moving passage while moving to the edge. Since the cooling member 47 is omitted from the center portion of the top 23a, the cooing member is prevented from being introduced into cooling space which is open below the center portion of the top to cause the convection to occur more actively, thereby further improving cooling efficiency.

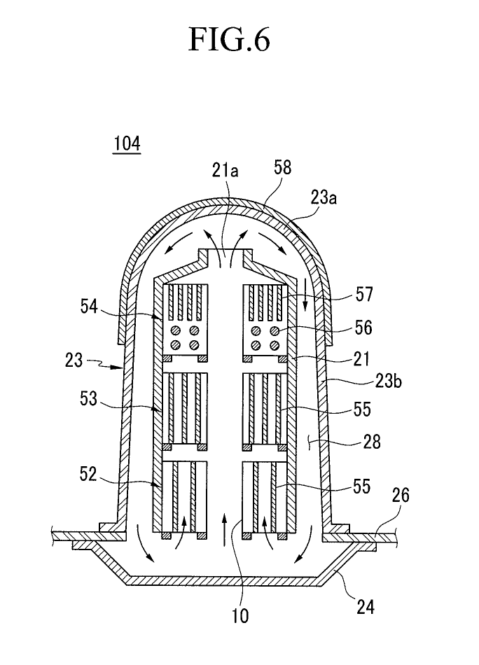

FIG. 6 is a cross-sectional view of a battery module according to a fourth exemplary embodiment of the present invention.

Referring to FIG. 6, the battery module 104 according to the exemplary embodiment has substantially the same structure as the battery module according to the third exemplary embodiment except for the configuration of protrusions 55, 56, and 57 and a cooling member 58. Therefore, the same structure will not be described again.

The battery module 104 according to the exemplary embodiment includes a plurality of battery arrays 52, 53, and 54 and a housing 23, and protrusions 55, 56, and 57 located between rechargeable batteries 10 of the battery arrays 52, 53, and 54.

Three battery arrays 52, 53, and 54 are spaced from each other along a flow direction of a cooling medium. Additionally, a first guide protrusion 55 is installed between the rechargeable batteries 10 of the battery array 52 located in the earliest part of the flow direction of the cooling medium and the battery array 53 located at the center. The first guide protrusion 55 has a bar shape extending in the flow direction of the cooing medium. The first guide protrusion 55 is elongate and extends from one end to the other end of the rechargeable battery 10.

The number of first guide protrusions 55 located between the rechargeable batteries of the battery array 53 located in the latter part of the flow direction of the cooling medium is larger than the number of first guide protrusions 55 located between the rechargeable batteries 10 of the battery array 52 located in the earlier part of the flow direction of the cooling medium.

Further, a second guide protrusion 57 and a dot protrusion 56 are installed between the rechargeable batteries 10 located in latter part of the battery arrays 52 and 53 where the first guide protrusion 55 is installed. The second guide protrusion 57 is installed in latter part of the protrusion on the basis of the flow direction of the cooling medium. As a result, the cooling medium passing through the dot protrusion 56 is guided by the second guide protrusion 57 to flow.

The second guide protrusion 57 extends in the flow direction of the cooling medium. Therefore, the second guide protrusion 57 extends from one end to about the center portion of the rechargeable battery 10. The dot protrusion 56 is formed in a portion of the battery where the second guide protrusion 57 is absent. As described in the exemplary embodiment, when both the second guide protrusion 57 and the dot protrusion 56 are located on one rechargeable battery 10, the cooling medium and the rechargeable battery 10 may be in contact with each other for enough time to cool the rechargeable battery 10 by the dot protrusion 56 and the cooling medium which is in contact with the rechargeable battery may be rapidly discharged through the second guide protrusion 57. When both the dot protrusion 56 and the second guide protrusion 57 are located on the same battery, cooling may be stably performed.

In one embodiment, the cooling member 58 is attached to an outer surface of the housing 23. Therefore, the cooling member 58 is in contact with the housing 23 while extending from the top 23a of the housing 23 to the side 23b of the housing 23. According to the exemplary embodiment, since the cooling member 58 is in contact with the housing 23 through a sufficient area, the cooling medium which moves to the upper part of the housing 23 may be cooled through the top 23a and is cooled by contacting the side 23b while passing through moving space. As a result, convection may occur more actively.

As such, according to the exemplary embodiment, since the velocity of the cooling medium further increases toward the latter part (i.e., towards the second end) of the cooling medium flow path, the convection in the housing 23 may occur more actively.

Further, the cooling member 58 is installed at the edge of the top 23a of the housing 23. The cooling member 58 serves to cool the housing 23 by receiving heat from the housing 23. The cooling member 58 may have various structures and may be made of a thermoelectric element, a metal plate transferring heat to other members, or the like.

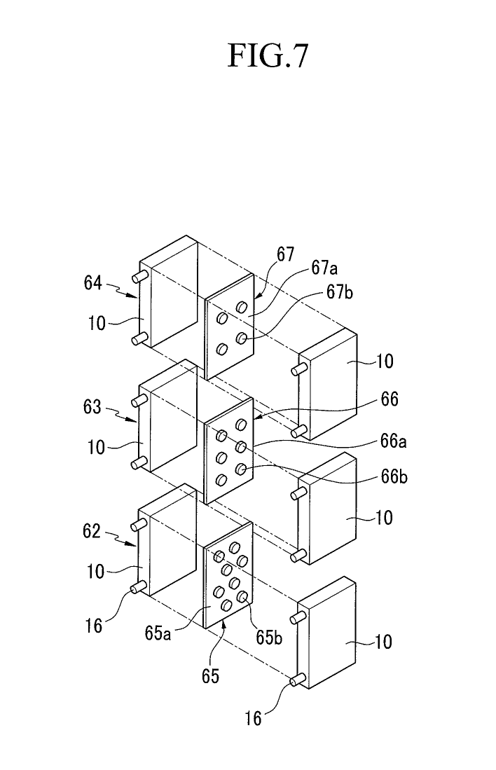

FIG. 7 is an exploded perspective view of rechargeable batteries constituting a battery module according to a fifth exemplary embodiment of the present invention.

Referring to FIG. 7, the battery module according to the exemplary embodiment has substantially the same structure as the battery module according to the first exemplary embodiment except for the configuration of partitions 65, 66, and 67. Therefore, the same structure will not be described again.

The battery module according to the exemplary embodiment includes a plurality of battery arrays 62, 63, and 64, a housing storing the battery arrays 62, 63, and 64, and protrusions 65b, 66b, and 67b located between rechargeable batteries 10.

The protrusions 65b, 66b, and 67b are fixed to plate materials 65a, 66a, and 67a located between the rechargeable batteries 10. Therefore, the protrusions 65b, 66b, and 67b and the plate materials 65a, 66a, and 67a are coupled with each other to form the partitions 65, 66, and 67. The partitions 65, 66, and 67 are located between the rechargeable batteries 10 to form a passage of a cooling medium.

The number of protrusions 67b of the partition 67 located in the latter part of the flow direction of the cooling medium is smaller than the number of protrusions 65b and 66b of the partitions 65 and 66 located in the earlier part of the flow direction of the cooling medium.

According to the exemplary embodiment, since the protrusion 65b, 66b, and 67b are fixed to the partitions 65, 66, and 67, the partitions 65, 66, and 67 are inserted between the rechargeable batteries 10, such that the protrusions 65b, 66b, and 67b may be easily located between the rechargeable batteries 10.

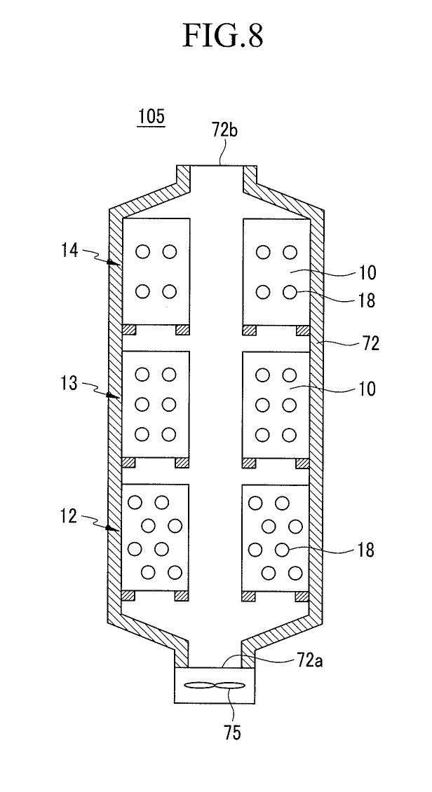

FIG. 8 is a cross-sectional view of a battery module according to a sixth exemplary embodiment of the present invention.

Referring to FIG. 8, the battery module 105 according to the exemplary embodiment has substantially the same structure as the battery module according to the first exemplary embodiment except for the configuration of a housing 72 and a blower 75. Therefore, the same structure will not be described again.

The battery module 105 according to the exemplary embodiment includes a plurality of battery arrays 12, 13, and 14 and a housing 72, and protrusions 18 located between rechargeable batteries 10 of the battery arrays 12, 13, and 14.

The housing 72 has a generally hexahedral body. An inlet 72a through which a cooling medium is introduced is formed at one end of the housing 72 and an outlet 72b through which the cooling medium is discharged is formed at the other end of the housing 72. The blower 75 compulsorily introducing the cooling medium into the housing 72 is installed in the inlet 72a. The cooling medium is formed by air and the blower 75 may be formed by a fan compulsorily transferring air.

Meanwhile, like the first exemplary embodiment, the number of protrusions 18 located between the rechargeable batteries 10 of the battery array 14 located in the latter part of the flow direction of the cooling medium is smaller than the number of protrusions 18 located between the rechargeable batteries 10 of the battery array 12 and 13 located in the earlier part of the flow direction of the cooling medium.

As a result, the friction between the battery arrays 12 and 13 located in the earlier part of the flow direction of the cooling medium and the cooling medium is larger than the friction between the battery array 14 located in the latter part of the flow direction of the cooling medium and the cooling medium.

According to the exemplary embodiment, since the velocity of the cooling medium increases to the latter part of the flow direction the cooling medium is supplied by the blower 75, the cooling medium may be rapidly moved even with small power. As a result, the cooling efficiency of the battery module 105 is improved and the loss of electric power by the blower 75 can be minimized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Description of Symbols

| | |
|---|---|
| 10: Rechargeable battery | 101, 102, 103, 104, 105: Battery module |
| 12, 13, 14, 32, 33, 34, 42, 43, | |
| 44, 52, 53, 54: Battery array | |
| 17: Case | 18, 35, 56, 65b, 66b, 67b: Protrusion |
| 19: Center passage | 21: Partitioning member |
| 23, 72: Housing | 23a: Top |
| 23b: Side | 24: Bottom plate |
| 25: Frame | 27: Cooling space |
| 28: Moving space | 36: Guide protrusion |
| 37, 47, 58: Cooling member | 38: Guide member |
| 55: First guide protrusion | 57: Second guide protrusion |
| 65, 66, 67: Partition | 65a, 66a, 67a: Plate material |
| 72a: Inlet | 72b: Outlet |
| 75: Blower | |

What is claimed is:

1. A battery module comprising:
a plurality of batteries stacked together to form a plurality of battery arrays, wherein a first group of the battery arrays are aligned together and a second group of the battery arrays are aligned together, and wherein the first group and the second group are spaced from each other to create a cooling medium flow path therebetween, the cooling medium flow path having a first end and a second end;
a housing accommodating the batteries; and
a plurality of protrusions on each of the batteries and spacing the batteries from each other, wherein a number of protrusions on a first battery of the batteries is different from a number of protrusions on a second battery adjacent to the first battery with respect to a flow direction of the cooling medium flow path.

2. The battery module of claim 1, wherein the first battery is located closer to the first end of the cooling medium flow path than the second battery, and wherein the number of protrusions on the first battery is greater than the number of protrusions on the second battery.

3. The battery module of claim 2, wherein the protrusions are spaced from each other on an outer surface of each of the batteries.

4. The battery module of claim 2, wherein a width of a first protrusion of the protrusions located on the first battery is greater than a width of a second protrusion of the protrusions located on the second battery.

5. The battery module of claim 2, wherein a length of a first protrusion of the protrusions located on the first battery is less than a length of a second protrusion of the protrusions located on the second battery.

6. The battery module of claim 2, wherein the protrusions comprise guide protrusions that are elongate and extend generally in a direction from the first end to the second end of the cooling medium flow path.

7. The battery module of claim 1, wherein the housing is sealed and is configured to allow the batteries to be cooled by convection.

8. The battery module of claim 7, wherein in an operating orientation, the first battery is located beneath the second battery.

9. The battery module of claim 8, wherein a cooling medium in the cooling medium flow path is heated by the batteries to move upwards from the first end to the second end of the cooling medium flow path.

10. The battery module of claim 7, wherein the first group of battery arrays extends along a first side of the cooling medium flow path and the second group of battery arrays extends along a second side of the cooling medium flow path substantially parallel to the first group.

11. The battery module of claim 7, further comprising a partitioning member, wherein the first group and the second group of battery arrays are within the partitioning member, wherein a cooling space is defined within the partitioning member and a moving space is defined outside of the partitioning member, and wherein a cooling medium can move between the cooling space and the moving space.

12. The battery module of claim 11, wherein the partitioning member comprises a thermal insulating material.

13. The battery module of claim 11, further comprising a guide member formed on the partitioning member, wherein the guide member extends obliquely from the partitioning member into the moving space.

14. The battery module of claim 1, wherein the housing further comprises a bottom plate configured to be exposed to exterior air.

15. The battery module of claim 1, further comprising a cooling member connected to the housing.

16. The battery module of claim 15, wherein the cooling member is located at generally one end of the housing.

17. The battery module of claim 15, wherein the cooling member is located at an edge of the housing.

18. The battery module of claim 17, wherein the cooling member has an opening and wherein a heat insulating member is in the opening and contacts the housing.

19. The battery module of claim 1, wherein the protrusions are fixed to a case of the battery.

20. The battery module of claim 1, wherein the protrusions are fixed to a plate located between the batteries.

21. The battery module of claim 1, wherein the protrusions comprise guide protrusions that are elongate and extend in a flow direction of the cooling medium flow path and dot protrusions having a greater width and a shorter length than the guide protrusions, and wherein the dot protrusions are closer to a first end of the flow path channel than the guide protrusions.

22. A battery module, comprising:
a plurality of batteries stacked together to form a plurality of battery arrays, wherein a first group of the battery arrays are aligned together and a second group of the battery arrays are aligned together, and wherein the first group and the second group are spaced from each other to create a cooling medium flow path therebetween, the cooling medium flow path having a first end and a second end; and
a housing accommodating the batteries;
wherein a first battery of the batteries located closer to the first end than a second battery of the batteries provides more flow resistance to cooling medium flow in the cooling medium flow path than the second battery.
